(19) United States
(12) Patent Application Publication
(10) Pub. No.: US 2026/0163666 A1
(43) Pub. Date: Jun. 11, 2026

(54) Sensor System For Environment Sensing, And Vehicle Having A Corresponding Sensor System, And Method For Operating A Corresponding Sensor System

(71) Applicant: Volkswagen Aktiengesellschaft, Wolfsburg (DE)

(72) Inventors: Thomas Gisder, Wolfsburg (DE); Heiko Gustav Kurz, Hannover (DE); Marc-Michael Meinecke, Sassenburg (DE)

(73) Assignee: Volkswagen Aktiengesellschaft, Wolfsburg (DE)

(21) Appl. No.: 19/057,915

(22) Filed: Feb. 19, 2025

(30) Foreign Application Priority Data
Feb. 19, 2024 (DE) 10 2024 201 501.6

(51) Int. Cl. H04J 14/02; H04B 10/2575

(52) U.S. Cl. CPC H04J 14/02; H04B 10/2575

(57) ABSTRACT

The disclosure relates to a sensor system for environment sensing, comprising a transmitter which is designed to emit electrical emission signals, a first transmission path which is designed to provide a first electrical emission signal to a first transmission unit, and a second transmission path which is designed to generate a second electrical emission signal and to provide it to a second transmission unit. A processor is designed to generate, on the basis of the optical carrier signal, a plurality of optical transmission signals that are frequency-shifted relative to one another, and to provide them to the transmitter, a signal generator of the transmitter, which is designed to generate the electrical emission signals on the basis of the optical transmission signals and to assign them to the relevant transmission path, and the transmission is designed to emit the first and second electrical emission signal simultaneously.

### CROSS-REFERENCE TO RELATED APPLICATIONS

This application claims priority to German Patent Application No. DE 10 2024 201 501.6, filed on Feb. 19, 2024 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a sensor system for environment sensing. The sensor system has an optical apparatus for generating an optical carrier signal. The sensor system also has a transmitter which has a plurality of transmission units, wherein the transmitter is designed to emit electrical emission signals.

The disclosure further relates to a vehicle having a corresponding sensor system.

The disclosure also relates to a method for operating a corresponding sensor system.

### SUMMARY

A need exist to provide an improved environment sensing by a sensor system, in which target objects, for example radar targets, can be detected more precisely and/or unambiguously.

The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of a vehicle having an example sensor system that comprises antenna elements of an antenna array that are arranged so as to be distributed on the vehicle;

FIG. 2 is a schematic representation of a block diagram of the example sensor system from FIG. 1;

FIG. 3 is a schematic representation of the vehicle from FIG. 1, showing an actual example antenna array and an example virtual antenna array for environment sensing;

FIG. 4 shows different emission signals which are frequency-shifted relative to one another;

FIG. 5 is a schematic representation, proceeding from FIGS. 3 and 4, of the simultaneous emission of frequency-shifted signals in order to virtually generate, on the basis thereof, a virtual example antenna array;

FIG. 6 is a schematic representation of an example electronic processor for providing an optical carrier signal for a transmitter and receiver of the sensor system;

FIG. 7 shows a schematic example embodiment of a sensor apparatus of the sensor system, wherein each transmission path here performs its own frequency conversion, and a corresponding receiver in order to be able to receive the simultaneously emitted signals;

FIG. 8 shows, proceeding from FIG. 7, a further example, wherein the receiver here is formed from a plurality of integrated circuits;

FIG. 9 shows, proceeding from FIGS. 7 and 8, a further example embodiment of the transmitter;

FIG. 10 shows, proceeding from FIGS. 7, 8 and 9, a further example embodiment of the transmitter;

FIG. 11 shows, in turn, a further example embodiment of a transmitter;

FIG. 12 shows a schematic further example embodiment of the processor of the sensor system;

FIG. 13 shows a further example embodiment of the transmitter, wherein each transmission path here filters or else selects, by means of a corresponding optical filter unit, the correspondingly appropriate signal from a plurality of optical signals;

FIG. 14 shows, proceeding from FIG. 13, a further example embodiment of the transmitter;

FIG. 15 shows, proceeding from FIGS. 13 and 14, a further example embodiment of the transmitter;

FIG. 16 shows, proceeding from FIG. 13 to 15, a further example embodiment of the transmitter; and

FIG. 17 shows, proceeding from FIG. 13, a further example embodiment of the transmitter.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments of a first aspect relate to a sensor system for environment sensing, comprising:
for example an optical apparatus for generating an optical carrier signal,
for example a transmitter which has a plurality of transmission units, wherein the transmitter is designed to emit electrical emission signals, having:
for example a first transmission path of the transmitter, which path is designed to provide a first electrical emission signal to a first transmission unit of the plurality of transmission units, which is arranged on the first transmission path,
for example at least one second transmission path of the transmitter, which path is different from the first transmission path and is designed to provide a second electrical emission signal, which is different from the first electrical emission signal, to a second transmission unit of the plurality of transmission units, which is arranged on the second transmission path,
for example a processor which is designed to generate, on the basis of the optical carrier signal, a plurality of optical transmission signals that are frequency-shifted relative to one another, and to provide them to the transmitter,
for example a signal generator of the transmitter, which is designed to generate the electrical emission signal on the basis of the optical transmission signals and to assign the electrical emission signals to the relevant transmission path on the basis of their respective frequencies,
for example the transmitter is designed to emit, simultaneously, in a transmission process, the first electrical emission signal with the first transmission unit and the second electrical emission signal with the second transmission unit.

system in some embodiments, better environment sensing can be carried out, in particular by virtue of the fact that simultaneous emission of different emission signals allows improved target detection or else object detection to be carried out. In other words, a simultaneous, concurrent or synchronous emission of frequency-shifted and/or frequency-modulated emission signals can be carried out. Thus, using the proposed sensor system, a plurality of signals that are frequency-shifted relative to one another, such as electrical emission signals, can be emitted into the surroundings in order to be able to carry out target detection or environment sensing on the basis of corresponding return signals or else reflected signals.

A further benefit of the simultaneous transmission or else emission of frequency-shifted transmission signals or else electrical emission signals is that, as a result, improved generation of a virtual antenna array can be carried out. The generation of virtual antenna arrays is of particular benefit to the signal processing and thus to the environment sensing. On the basis of the emitted and received signals, a plurality of virtual antenna elements, or else a virtual antenna array, can be deployed so that as a result, for example, the resolution of the sensor system can be increased. For this purpose, the proposed sensor system can, for example, be in the form of a photonic multiband radar.

The terms ‘electrical emitted signals’, ‘electrical receive/reception signal’, and ‘signal’ generally are understood herein to refer to electromagnetic signals when emitted/sent and received by the antennas.

Using the proposed sensor system, a signal-to-noise ratio (SNR) can be increased. Furthermore, lower phase noise can be provided with the proposed sensor system. Furthermore, the proposed sensor system can be used to carry out flexible chirp generation. Furthermore, by means of the proposed sensor system, the number of optical phases can be lowered.

For example, the proposed sensor system can be co-integrated in EPIC processes in SiGe—SiN, CMOS and hybrid BiCMOS.

In particular, the proposed sensor system can be produced and operated with lower costs in some embodiments. Furthermore, the proposed sensor system can have higher resolution in some embodiments. Furthermore, the proposed sensor system has the benefit that its range is increased in some embodiments. And, by means of the proposed sensor system, direct generation of virtual equipment can be carried out in some embodiments.

The transmitter can have, for example, different transmission antennas, transmission elements or antenna elements which can emit the electronic emission signals into the surroundings. For example, a transmitter unit can comprise one or more transmission elements such as antenna elements. For this purpose, one or more transmission units can be arranged on a particular transmission path of the transmitter. Thus, for example, an antenna array can be deployed.

The transmission units can be in the form of circuits, for example, so that each transmission path or else circuit can be used for emitting a particular electrical emission signal. For example, each transmission path or else transmission module can be used in order to be able to carry out an emission of such a signal that has, in comparison to the other transmission paths and the signals emitted therein, a different or else frequency-shifted frequency.

The optical carrier signal, which can be referred to as an optical transmission signal, for example, can be generated by the optical apparatus, like for example an optical signal source or a laser apparatus, and be provided to the transmitter. The transmitter or a corresponding transmission path can, on the basis of the optical carrier signal, generate, convert and/or modulate an electrical emission signal in such a way that electrical emission signals that are different from one another are provided.

As already discussed at the outset, using the proposed transmission system, the transmission paths and, in particular, the different transmission units can be controlled so that, in a particular transmission process or else transmission mode, all transmission units can emit simultaneously or concurrently the electrical emission signals which are frequency-shifted relative to one another in some embodiments. As a result, improved environment sensing and, in particular, target detection can be achieved.

For example, the transmitter can control a transmission process or the transmitter for example receives from a higher-level system of the transmission systema corresponding control signal for carrying out the transmission process.

By means of the processor, which for example may be a central unit (e.g. a computer or computing apparatus) that has a central processor, a plurality of optical transmission signals can be generated or else converted and/or modulated. This occurs on the basis of an optical carrier signal. Using the plurality of optical transmission signals, the proposed sensor system can carry out, in the transmission process, concurrent emission of electrical emission signals that are frequency-shifted relative to one another. The optical transmission signals can be frequency-shifted and/or frequency-modulated relative to one another so that, in the transmission process, a plurality of electrical emission signals different from one another can be emitted. By means of the signal generator, which can be an optical-electronic unit, the optical transmission signals can be converted accordingly, i.e., an optical-electrical conversion, so that the electrical emission signals can be provided. The electrical emission signals also have accordingly different frequencies, frequency bands or frequency ranges. On the basis of the respective frequencies of the electrical emission signals, the signal generator can carry out a selection or else an assignment. In this case, the respectively associated electrical emission signals are assigned to the respective transmission paths. This can be done on the basis of the frequencies. Thus, with a particular transmission path and, in particular, with the particular transmission unit of the particular transmission path, a corresponding electrical emission signal differing from the other electrical emission signals can be emitted.

Due to physical interrelationships, the angular resolution of a sensor system, in particular of a radar system, is determined by the extent of the antenna aperture thereof. “Antenna aperture” is understood as the surface on which the individual antennas are arranged in a distributed manner. Current sensor systems are mostly modules having a size of around 10×10 cm², which is restricted due to the integrability in vehicles. The angular resolution is accordingly limited to approx. 2 degrees. Here, the resolution improves proportionally to the size of the aperture. If two objects are to be resolved in angle, i.e., in azimuth and elevation, an aperture that is extended in two directions is required. The teachings herein are beneficial here.

A second important variable in an antenna array is the spacing between the individual antenna elements. This variable determines the measurable angular range. Larger antenna spacings lead to ambiguities such as side peaks in the angle measurement. Radar systems in the automotive industry thus use so-called virtual antenna elements. A virtual element of this kind results from the combination of a transmission antenna with a receiving channel and specifically exactly on the center of the connection vector. With n-transmission antennas and m-receiving antennas, a virtual array consisting of a maximum of n×m elements can be produced. This principle is commonly known as “multiple input multiple output (MIMO)”. Using the proposed sensor system, the clearly measurable angular range of the antenna array can be increased.

In order to sense the environment as reliably as possible, a signal-to-noise ratio that is as high as possible and stable signal generation in the sensor are required. This is required, in particular, in the case of large apertures with thinned antenna arrangements, in order to detect targets clearly. The proposed sensor system may provide a remedy to this in some embodiments.

Specifically, the range of contemporary 77-GHz radars is limited by the maximum emitted power and the array pattern.

In particular, the transmitter and an optional receiver can be integrated on a single semiconductor chip, for example in a CMOS, SiM CMOS, Bi CMOS, hybrid BiCMOS, or with processes on photonic-electronic co-integrated chips. Therefore, for example, with the aid of the teachings herein, a radar sensor device or sensor system can be produced by means of mass manufacturing by means of standardized semiconductor processes.

For example, using the sensor system, frequency conversion of a terahertz carrier signal in the gigahertz frequency range can be carried out after optical signal transmission and, conversely, reception of gigahertz signals with modulation to a terahertz carrier signal.

For example, the proposed sensor system can be used in motor vehicles. For example, the sensor system can be used in motor vehicles that are, for example, at least partially autonomously operated, in particular operated fully autonomously. For such automated travel, reliable perception of the environment is required, which may be achieved using the sensor system. The environment or else surroundings can be sensed here by means of sensors, for example radar, lidar, and camera. These could be examples of the field of application of the radar sensor device. Comprehensive 360-degree three-dimensional sensing of the surroundings can be carried out by means of the sensor system, such that all static and dynamic objects can be sensed.

Alternatively and in some embodiments, the sensor system can be applied to lidar, since lidar, in particular, plays a crucial role in redundant, robust environment sensing, since this sensor type can measure distances and angles more precisely in environment sensing and can also be used for classification.

For example, the sensor system can be used in motor vehicles that are, for example, at least partially autonomously operated, but in particular also those that are operated fully autonomously. However, in order to make such automated travel possible, reliable perception of the environment is essential. Here, the environment or else surroundings is sensed by means of sensors, for example radar, lidar, or camera. Comprehensive 360-degree three-dimensional sensing of the surroundings is particularly important, such that all static and dynamic objects can be sensed. The sensor system can be used for this purpose. In particular, lidar plays a crucial role in redundant, robust environment sensing, since this type of sensor can measure distances more precisely in environment sensing and can also be used for classification. However, these lidar sensors are cost-intensive and complex in terms of design. In particular, 360-degree three-dimensional environment sensing is problematic, since either many smaller individual sensors are required to ensure this, which as a rule work with many individual light sources and detector elements, or large lidar sensors are installed. Furthermore, lidar sensors are susceptible to weather influences such as rain, fog, or direct insolation. The sensor system may provide a remedy to this in some embodiments.

Radar sensors or else sensor systems are also well known in motor vehicle construction and reliably provide data in a fail-safe manner in all weather conditions. Even poor visibility, for example with rain, fog, snow, dust, or darkness, barely influence their perceptive reliability. However, according to the prior art, the resolution has thus far been limited, in particular series radars currently in use are only designed with an angular resolution of about 2 degrees. In order to meet the requirements for an increased level of automation in motor vehicle construction with reliable driving functions, it is provided that the radar sensor device provides three-dimensional images with a high angular resolution in the region of less than or equal to 0.1 degrees with a low sensitivity to interferences in the surroundings. This is not achieved with the conventional radar technology according to the prior art, since the resolution of such systems is too low.

The sensor system may be designed as a photonic radar sensor device, which increases the resolution by co-integrating electronic and photonic components in a single semiconductor chip. The tracking of a FMCW signal as well as the overall signal processing and signal evaluation are carried out in the central station. Each transceiver module comprises an electronic-photonic co-integrated chip, known as an EPIC chip. Silicon photonics technology is used for the co-integration. This allows for monolithic integration of photonic components, high-frequency electronics, and digital electronics together on a chip. The technical innovation of such a system lies in the signal transmission of gigahertz signals by means of the optical carrier signal in the terahertz frequency range. A central station, which can also be referred to as a central electronic processor, generates an optical carrier frequency in terahertz. In this way, the transmitted signal is modulated with one eighth of the radar frequency and the optical fiber is sent to the antenna chips. Frequency multiplication takes place on these chips, such that the radar radiation can be emitted by the antenna chips. The signal detection takes place in reverse. All data are processed on the central station.

However, a design of this kind is very complex in the implementation of gigahertz electronics at the chip level. For example, the frequency multiplication that takes place on the chip after detection by means of a photodiode is technically challenging and poses a significant challenge with regard to the gigahertz signal generation with a high signal-to-noise ratio and as little jitter as possible. Therefore, the gigahertz signal must be laboriously stabilized in further steps. Furthermore, gigahertz electronics are cost-intensive. Furthermore, stringent power requirements are imposed on the optical carrier, in particular the laser, since a lot of optical power is required to generate a highly precise gigahertz signal, which makes ring lines with the only phase for a radar array with many distributed radar semiconductor chips difficult to realize. For example, two photonic-electronic semiconductor chips are also required for a relevant transmission and receiving channel, which incurs further costs. The problems mentioned just above may be solved at least partially using a sensor system according to some embodiments.

For example, the disclosure utilizes the fact that the radiation of the laser apparatus, which may in particular also be designed as a CW laser, is coupled in in a photonic semiconductor by means of an optical interface. This may be the optical transmission signal or else a carrier signal of the CW laser.

In this case, the generation of the FMCW signal as well as the overall signal processing and evaluation are carried out by a central station, for example the processor. Each transceiver module consists of an electronic-photonic co-integrated chip (“EPIC chip”). Silicon photonics technology is used for the co-integration. This allows for monolithic integration of photonic components, high-frequency electronics, and digital electronics together on a chip (“electronic-photonic co-integration”). The technical innovation of such a system lies in the signal transmission of GHz signals by means of an optical carrier signal in the THz frequency range. A central station generates an optical carrier frequency (THz). In this way, the signal to be transmitted is modulated with ⅛ of the radar frequency and sent via optical fiber to the antenna chips. Eightfold multiplication of the frequency takes place on these chips, such that the radar radiation can be emitted by the antenna chips. The signal detection takes place in reverse. All data are processed on the central station.

The principle of electronic-photonic co-integration in a chip, with silicon-on-insulator regions for the photonic components and bulk silicon regions for the electronic circuits is a technology that is unique in the world. For example in the case of high data rates, a high signal quality can thus be realized with few parasitic interferences. The connection of the HF circuits for the radar antennas, including frequency multipliers to the optical transceiver, can be implemented without additional wire or flip chip bonding. In addition, chips can already be optically and electrically tested at the wafer level, as a result of which a high yield can be achieved in the further module setup. With this technology, extremely compact form factors can be realized and, associated with this, a high relevance for the application of optical technologies on the basis of silicon photonics in the automotive industry.

The obstacle for productive use of optical fibers is the lack of scalability of currently available technologies. This scalability to large volumes is made possible by means of the technology for the highly integrated manufacture of electronic-photonic integrated circuits. The result is a significant cost reduction in the assembly technology and a more efficient cost structure. Comprehensive libraries for electronic and photonic components for high-bandwidth data transmission, which are used in the project, have been developed from data center solutions.

In some embodiments, the transmitter has a third transmission path which is different from the first and second transmission path. With the third transmission path, a third electrical emission signal, which is different from the first and/or second electrical emission signal, can be provided to a third transmission unit of the plurality of transmission units, which is arranged on the third transmission path. For example, the third electrical transmission signal can be different in comparison with the second electrical emission signal and/or the first electrical emission signal, i.e., have a different frequency. The third transmission unit or further transmission units can each have their own at least one transmission unit, so that with a corresponding transmission path of the transmitter a corresponding electrical emission signal frequency-shifted in comparison with the others can be emitted.

Optionally, the transmitter can have a plurality of transmission paths, i.e., more than three transmission paths. For this purpose, the signal generator is also designed to generate the third electrical emission signal on the basis of the optical transmission signals and to assign it on the basis of its frequency to the third transmission path. In this way, a particular transmission path of the transmitter can be assigned a matching electrical emission signal.

Accordingly, the transmitter can be designed, for example using a controller, to emit simultaneously, in the first transmission process, the first electrical emission signal with the first transmission unit, the second electrical emission signal with the second transmission unit and the third electrical emission signal with the third emission unit and/or further electrical emission signals with further transmission units.

In some embodiments, the signal generator has an optical filter unit which is designed to filter the optical transmission signals on the basis of their respective frequencies. With this optical filter unit, i.e., an optical filter, the optical transmission signals, which are provided for example having a multiband signal, can to select or else divide so that a particular transmission path can be assigned an associated electrical emission signal. For this purpose, the signal generator can also have an optical-electrical conversion unit which is designed to convert the filtered optical transmission signals into the electrical emission signals. Therefore, first, a selection in the optical range can take place and the selected optical signals can then accordingly be transferred into an electrical signal in order to then be provided to the respective transmission paths. For this purpose, the signal generator can also have an electronic distributor which is designed to provide the respectively associated converted electrical emission signals to the transmission paths. Therefore, electronic switching can take place between the transmission paths in order to assign or else provide the associated electrical emission signal to a corresponding transmission path.

In some embodiments, the signal generator has an optical filter unit which is designed to filter the optical transmission signals on the basis of their respective frequencies, wherein the optical filter unit can be controlled using an electronic filter controller (electronic filter control unit). Thus, for example, a unit separate from the transmitter, such as the filter controller, which in turn can be part of the sensor system, can provide the corresponding electrical emission signals to the corresponding transmission paths and thus to the corresponding transmission unit. In this case, first the filtering or else the selection takes place in the optical range. For this purpose, the signal generator can have an optical distributor which is designed to provide the respectively associated optical transmission signal to the transmission path. Therefore, after the filtering or else selection of the respective optical transmission signals, the optical transmission signal associated with or else matching a particular transmission path can be supplied or else provided. In order to convert, in turn, this signal into a corresponding electrical signal, each transmission path can have a corresponding optical-electrical converter which is designed to convert the optical transmission signal provided by the optical distributor into the electrical emission signal associated with the transmission path. In other words, the first transmission path can have a first converter, the second transmission path can have a second converter and the third transmission path can have a third converter. In particular, each transmission path can have its own converter. Such an optical-electrical converter can be a photodiode or a phototransistor, for example.

In some embodiments, the signal generator has an optical filter unit which is designed to filter the optical transmission signals on the basis of their respective frequencies. The signal generator can also have an optical-electrical converter which is designed to convert the filtered optical transmission signals into the electrical emission signals. For example, the optical filter unit and the optical-electrical converter can be controlled or else regulated by means of an electronic unit such as an electronic filter controller. Thus, in turn, the electrical emission signals can be processed or else prepared accordingly for the transmission paths. In this case, in contrast to the previous embodiments, each transmission path can have a corresponding electronic filter unit which is designed to select the electrical emission signal associated with the corresponding transmission path from the converted electrical emission signals. In other words, by means of the signal generator, all necessary or else conceivable electrical emission signals are maintained or else provided for their transmission paths. In order for each transmission path to provide or else be transferred the corresponding or else matching electrical emission signal, each transmission path can filter or else select independently from the plurality of electrical emission signals the electrical emission signal appropriate for it.

In some embodiments, the signal generator also has a first optical filter unit and at least one second optical filter unit, wherein the first optical filter unit is integrated in the first transmission path and the second optical filter unit is integrated in the second transmission path. Therefore, in contrast to the previous embodiments, here each transmission path can have its own optical filter unit. The first optical filter unit can be designed to filter such an optical transmission signal of the plurality of optical transmission signals on which the first electrical emission signal is based and the second optical filter unit is designed to filter such an optical transmission signal of the plurality of optical transmission signals on which the second electrical emission signal is based. In other words, the plurality of optical transmission signals are transmitted to the transmitter, where a corresponding optical filter unit of a corresponding transmission path can select or else filter out the optical transmission signal intended for the corresponding transmission path. This signal can in turn be converted independently by the transmission path into the corresponding electrical emission signal.

In some embodiments, the first transmission path and at least the second transmission path are located together on a common integrated circuit. Therefore, the transmitter can contain the corresponding transmission paths so that the transmitter can be realized more compactly. Therefore, all corresponding units which are required for the simultaneous emission of the electrical emission signals frequency-shifted can be integrated on a module or else a circuit. For example, the transmitter can be in the form of a one-chip system. Therefore, the transmitter can be a “one-chip solution”.

Alternatively and in some embodiments, it is also conceivable that the first transmission path and at least the second transmission path are each located on their own integrated circuit. Thus, for each transmission path its own chip can be provided, so that the respective transmission paths to which the respective transmission units are arranged or else integrated can be used flexibly according to the application of the sensor system. This is primarily beneficial if the sensor system is used in the automotive industry. In this case, the respective transmission paths, which can in turn have individual antenna elements, can be formed separately in order to be able to arrange said elements so as to be distributed around the vehicle, for example.

In some embodiments, the sensor system has a receiver which has a plurality of receiving units, wherein the receiver is designed to receive electrical reception signals which are based on the emitted electrical emission signals. The receiver can, for example, be a unit which is isolated or else separate from the transmitter. By means of the receiver, the electrical emission signals emitted simultaneously in the transmission process can be received when they are reflected by objects, such as target objects, in the surroundings. This receiver can have a plurality of receiving units, for example receiving antennas or antenna elements.

It is also conceivable for each receiving unit to be arranged on a reception path. Therefore, in some embodiments of the transmitter, the receiver can have a plurality of reception paths, wherein at least one receiving unit is assigned to each reception path. After a particular receiving antenna has received an electrical reception signal, this can optionally be amplified by a corresponding amplifier unit before the actual signal processing or else environment sensing is carried out.

For example, the receiver can be in the form of a unit or else an integrated circuit so that all receiving units are arranged or else integrated on a common unit or else on a common integrated circuit. It is also conceivable for the individual receiving units to be arranged on their own integrated circuits or else modules, as a result of which the receiving units are separated from one another physically and spatially. As a result, the transmitter can in turn also be used flexibly.

In some embodiments, the receiver has a signal processor which is coupled to the receiving units, wherein the signal processor is designed to mix an electrical reception signal of the electrical reception signals with an electrical carrier signal that can be generated by an optically required electrical conversion of the optical carrier signal. By means of the signal processor, which can be an electrical and/or electronic system, the received signals of the receiving units can be pre-processed so that, as a result of this pre-processing, the subsequent environment sensing or else target detection can be carried out more simply and, in particular, more efficiently. For this purpose, the signal processor, for example, can mix the received electrical reception signals of the receiving units with the original transmission signal. The original transmission signal is to be understood here to mean an electrical reception signal that occurs on the optical carrier signal. In other words, the optical carrier signal of the transmitter is transmitted on the receiver so that the relevant information can be worked out on the basis of the received information signals in order to be able to carry out corresponding target detection and/or environment sensing.

A further aspect of the disclosure relates to a vehicle having a sensor system according to the teachings herein or an embodiment thereof.

For example, the vehicle may be a manually operated vehicle, a partially autonomously operated vehicle, or a fully autonomously operated vehicle. In other words, the vehicle may be a highly automated vehicle.

In particular, the vehicle may be a motor vehicle, for example a passenger car or truck.

For example, the antenna array can have multiple antenna elements that are arranged so as to be distributed at a distance from one another on the vehicle. Therefore, sensing of the surroundings of the vehicle that is as efficient as possible can be carried out. On account of the distributed arrangement of the individual antenna elements on the vehicle, 360-degree environment sensing, in particular, can be carried out.

For example, the antenna elements of the antenna array may be designed in a “sparse array” configuration. In particular, the antenna elements of the antenna array may be arranged in a sparsely or thinly populated configuration on the vehicle.

Embodiments of individual aspects of the disclosure should be considered to be embodiments of other aspects. In particular, the respective embodiments of individual aspects can be considered to be embodiments of all other aspects. This also applies vice versa.

A further aspect of the disclosure relates to a method for operating a sensor system according to the previous aspect or an embodiment thereof, the method comprising the following:
generating the optical carrier signal,
generating the plurality of optical transmission signals which are frequency-shifted relative to one another,
generating the electrical emission signals on the basis of the optical transmission signals,
assigning the electrical emission signals to the relevant transmission path on the basis of their respective frequencies,
providing the first electrical emission signal to the first transmission unit,
providing the second electrical emission signal to the second transmission unit,
simultaneously emitting the first and second electrical emission signal in the transmission process.

Using the proposed method, a sensor system such as the sensor system according to the teachings herein can be operated more efficiently. In particular, the proposed method allows improved environment sensing and, in particular, more exact or else precise target detection of targets in the surroundings of a sensor system.

Above all, the electrical emission signals, which are a plurality of signals, can be emitted simultaneously, concurrently or synchronously. In other words, by means of the proposed method, the sensor system can be operated in such a way that simultaneous emission of signals which are frequency-shifted and/or frequency-modulated relative to one another can be carried out in one transmission process. On the basis of these simultaneous emissions of the emitted signals, corresponding return signals or else reflected signals in the surroundings can be received so that, on the basis of the simultaneously emitted emission signals and the corresponding received signals, environment sensing and/or target detection can be carried out.

In some embodiments, it is furthermore the case that electrical reception signals based on the emitted electrical emission signals are received immediately after the transmission process, wherein, on the basis of the simultaneously emitted electrical emission signals and the received electrical reception signals, a virtual antenna array related to the transmission system is generated, wherein, by means of the generated virtual antenna array, signal processing can be carried out for environment sensing. By means of this virtual generation of virtual antennas in order to increase, for example, the lower number of physical antennas using software, i.e., virtually, a resolution of the sensor system can be increased. In particular, cost savings can be made since the number of physical, i.e., actual, antennas can be reduced. On the basis of the emitted signals and the received signals and the arrangement of the actual or else physical receiving units and/or transmission units, further virtual antenna elements can be reconstructed. For example, a virtual antenna can be generated between two physical antennas, so that the processing of data, information and/or signals can be carried out more efficiently or else in an improved manner. First and foremost, this can improve the environment sensing, in particular the target detection of the sensor system.

By means of the teachings herein, for example a single-shot method for generating a virtual antenna array can be realized or else implemented using a photonic multiband radar.

A further aspect of the disclosure relates to a vehicle having a sensor system according to the previous aspect or an embodiment thereof.

For example, the vehicle may be a manually operated vehicle, a partially autonomously operated vehicle, or a fully autonomously operated vehicle. In other words, the vehicle may be a highly automated vehicle.

In particular, the vehicle may be a motor vehicle, for example a passenger car or truck.

For example, the antenna array can have multiple antenna elements that are arranged so as to be distributed at a distance from one another on the vehicle. Therefore, sensing of the surroundings of the vehicle that is as efficient as possible can be carried out. On account of the distributed arrangement of the individual antenna elements on the vehicle, 360-degree environment sensing, in particular, can be carried out.

For example, the antenna elements of the antenna array may be designed in a “sparse array” configuration. In particular, the antenna elements of the antenna array may be arranged in a sparsely or thinly populated configuration on the vehicle.

Embodiments of individual aspects should be considered to be embodiments of other aspects. In particular, the respective embodiments of individual aspect can be considered to be embodiments of all other aspects. This also applies vice versa.

Embodiments of the method or else of the methods should be considered to be embodiments of the sensor system and of the vehicle. In this regard, the sensor system and the vehicle have objective features that make it possible to carry out the method or a beneficial embodiment thereof.

For application scenarios or application situations which may result with the method and which are not explicitly described here, it can be provided that, according to the method, an error message and/or a request to input user feedback is output and/or a standard setting and/or a predetermined initial state is set.

The disclosure also includes developments of the method according to the teachings herein and of the vehicle according to the teachings herein that have features which have already been described in conjunction with the developments of the sensor system according to the teachings herein. For this reason, the corresponding developments of the method and of the vehicle will not be described again.

In the embodiments described herein, the described components of the embodiments each represent individual features that are to be considered independent of one another, in the combination as shown or described, and in combinations other than shown or described. In addition, the described embodiments can also be supplemented by features other than those described.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

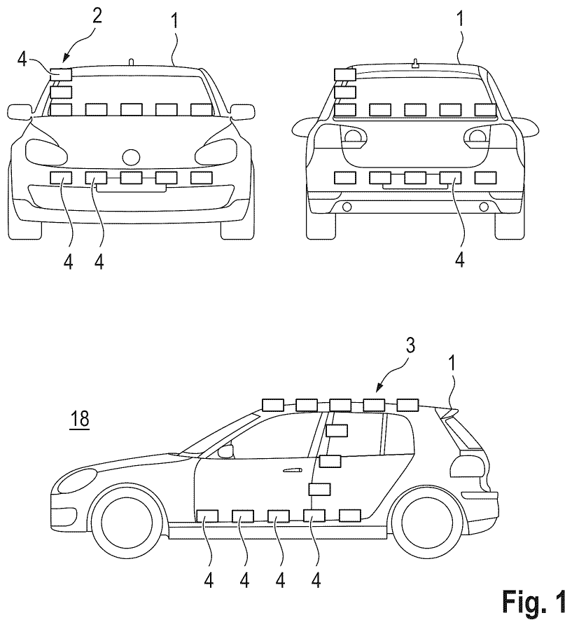

FIG. 1 shows various schematic views (front view, rear view, side view) of a vehicle 1, which may be a motor vehicle. The vehicle 1 includes, for example, a sensor system 2.

The sensor system 2 may be, for example, a radar system or an environment sensor system of the vehicle 1. For this purpose, the sensor system 2 may, for example, be communicatively linked to one or more driver assistance systems or other vehicle systems. For example, the sensor system 2 may be a radar sensor or a lidar sensor or another sensor type, in particular for vehicles. In addition to the use of the sensor system 2 in the vehicle 1, said sensor system can also be used in vehicle-external systems.

For example, the sensor system 2 comprises at least one antenna array 3 or multiple antenna arrays. The antenna array 3 may, in turn, be formed of a plurality of antenna elements 4. The antenna elements 4 may, in particular for 360-degree environment sensing, be arranged so as to be distributed at a distance from one another on the vehicle 1.

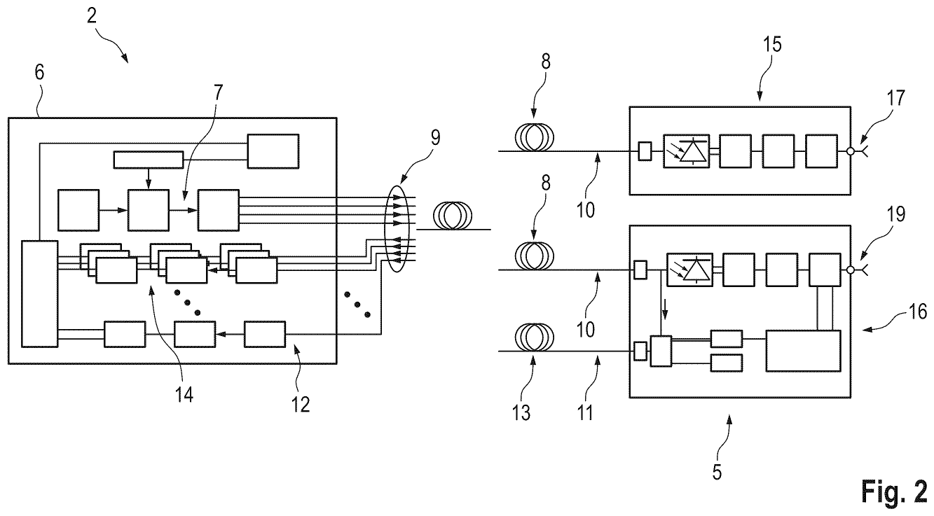

FIG. 2 shows a conceivable embodiment of the sensor system 2. The sensor system 2 may at least comprise a radar sensor device 5 and a central electronic processor 6. For example, the radar sensor device 5 and the central electronic processor 6 may be distinct and physically separated units. The radar sensor device 5 may, for example, comprise the at least one antenna array 3. Otherwise, the antenna array 3 may serve as the radar sensor device 5.

The central electronic processor 6 is a central unit. For example, the central electronic processor 6 may generate an electrical control signal by means of which a laser apparatus 7 can be actuated or else controlled. The laser apparatus 7 may, for example, be a CW laser. An optical transmission signal or else a carrier signal 8 may be generated by means of the laser apparatus 7. The optical transmission signal 8 may, in particular, be referred to as an optical carrier signal in the terahertz frequency range. The central electronic processor 6 may, for example, generate the optical carrier frequency. The signal to be transmitted is modulated to this optical carrier frequency with one eighth of a radar frequency and, for example, transmitted to the radar sensor device 5. In this way, the frequency can be multiplied by eight. In turn, signals in the gigahertz frequency range can be received and transmitted to the central electronic processor 6 by means of the radar sensor device 5.

For example, the central electronic processor 6 can be coupled in each case via at least one glass fiber 9 to an optical input 10 and optical output 11 of the radar sensor device 5. As a result, bidirectional signal transmission can take place between the central electronic processor 6 and the radar sensor device 5.

For example, the central electronic processor 6 may be referred to as an electronic evaluation unit.

The central electronic processor 6 may further comprise an optical receiving unit 12 which is configured to receive an optical output signal 13 that is provided to the radar sensor device 5 by means of the optical output 11. Therefore, the central electronic processor 6 can be coupled to the radar sensor device 5 via optical fiber or electronic interface, for example Ethernet. In particular, multiple radar sensor devices or antenna arrays can be coupled to the central electronic processor 6. For example, the central electronic processor 6 may comprise a processing unit 14 or else a computing unit, by means of which the received optical output signal can be processed. As a result, signal sensing and subsequent data processing of the received output signal 11 can be carried out.

In particular, the central electronic processor 6 may comprise or else provide all required control signals, data processing signals, modules, and interfaces.

For example, the radar sensor device 5 may comprise, in addition to the optical input 10 and the optical output 11, at least one transmitter 15 or transmission antenna and at least one receiver 16 or receiving antenna. Therefore, the radar sensor device 5 comprises a receiving module and/or transmission module. In particular, the transmitter 15 and the receiver 16 may be integrated on one and the same chip. It is also conceivable for these to be located on different semiconductor chips.

An electrical radar emission signal 17 that is based on the optical transmission signal 8 may be emitted into surroundings 18 of the vehicle 1 by means of the transmitter 15. A corresponding radar signal 17 may therefore be emitted depending on the optical transmission signal 8. If this signal 17 is then reflected by objects, such as road users, roads, trees, or other objects, in the surroundings 18, an electrical reception signal 19 that corresponds to the electrical radar emission signal 17 and that is reflected in the surroundings 18 can be received.

For example, the transmitter 15 may comprise at least one antenna or else an antenna unit or multiple antennas for the emission.

For example, the emitted radar emission signal 17 or else electrical emission signal and the received reception signal 19 may be in the terahertz frequency range or gigahertz frequency range. Therefore, by means of the sensor system 2, frequency conversion of a terahertz carrier signal, in particular a transmission signal 8, may be carried out into the gigahertz frequency range for emission. Conversely, gigahertz signals may be received with modulation to a terahertz carrier signal. For example, the transmitter 15 may comprise at least one grating coupler and a photodiode for the emission. The receiver 16 may, for example, comprise two jitter couplers, a photodiode, and a modulator for the reception.

By means of the sensor system 2, modulation with ⅛ of the radar frequency and transmission by optical fiber to the antenna chips or else antenna elements 4 are possible. Specifically, eightfold multiplication of the frequency takes place on these chips or elements, such that the radar radiation can be emitted by the antenna chips. The signal detection optionally takes place in reverse. All data can be processed on the central station.

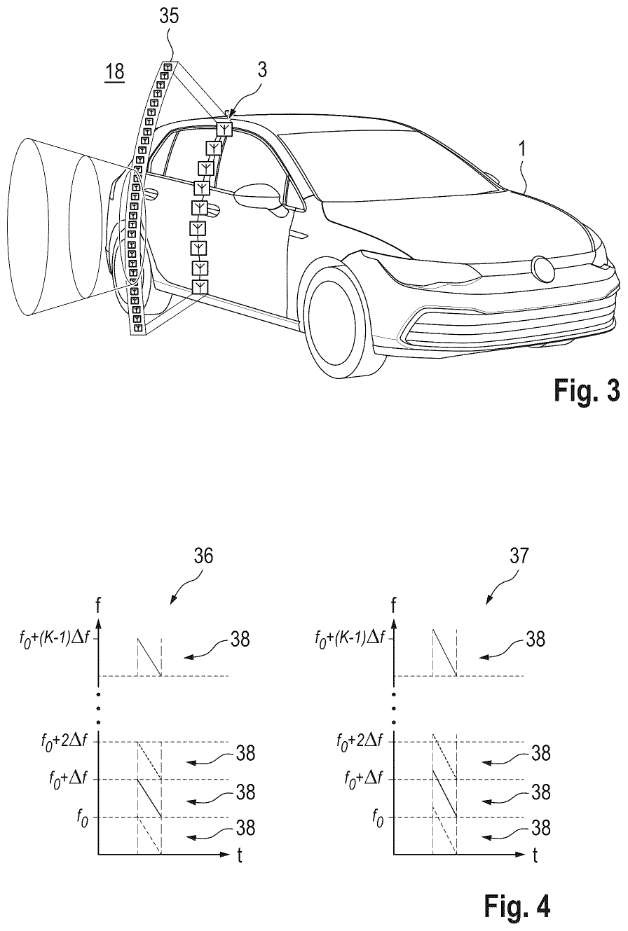

FIG. 3 shows a further schematic representation of the vehicle 1, wherein, by way of example, the antenna array 3 or another antenna array of the sensor system 2 is arranged on the vehicle 1 such that environment sensing can be performed to the side of the vehicle 1. In other words, it shows an arrangement of transmission or receiving antennas, for example the antenna array 3, in elevation. A further embodiment with azimuthal expansion can likewise be conceived and realized.

In order to perform improved environment sensing, it is beneficial if each sensor system or the sensor data processing is not limited to only one individual frequency band. In the automotive industry, for example, 77 GHz or 24 GHz is typically used today, the sensors being operated in these ranges. However, both frequencies can be limited in terms of their maximum range by the maximum emitted power; furthermore, two different photonic-electronic semiconductor chips are needed for the transmission and receiving channel, which leads to higher costs. To remedy this, miniaturized photonic co-integrated radar chips are used in a coherent distributed antenna array that is integrated over large areas in and on the vehicle. In this case, conversion of the optically transmitted radar signal to an electronic-photonic co-integrated semiconductor circuit can be conceived in at least two different frequencies. For this purpose, furthermore, simultaneous synchronous emission of a frequency-shifted and/or frequency-modulated transmission signal is carried out. Optically linking the radar chips to a coherent overall system is likewise conceivable and time-delayed reception signals can be mixed with a frequency-modulated transmission signal. These approaches are used by the teachings herein to be able to improve environment sensing with the sensor system 2.

To achieve cost savings at the same time, in particular due to fewer antenna elements with nevertheless a higher resolution and thus better directional probability, a virtual antenna array 35 can be generated by computer. In other words, this means that by simultaneously emitting emission signals which are frequency-shifted relative to one another, a virtual antenna array 35 can be generated. In other words, the virtual antenna array 35 is generated by simultaneous emission of frequency-modulated multiband radar signals.

In the subsequent FIG. 4, two schematic frequency diagrams 36, 37 are shown by way of example. The diagram 36 shows exemplary frequency-modulated multiband transmission signals 38. These can be emitted by a plurality of transmission units, such as the antenna elements 4, for example simultaneously. The frequency swing by which the different frequency bands of the signals 38 are shifted relative to one another may, as in diagram 36, not interfere with one another or, as in diagram 37, the different signals 38 may interfere in an adjacent frequency band or else in the frequency of the subsequent signal 38. In other words, the signals in the diagram 36 do not overlap in terms of their frequency bands. In the diagram 37, the frequency bands of the signals 38 can overlap. A particular benefit of the overlapping is that a larger virtual piece of equipment 35 can be deployed.

As shown, for example, in FIG. 3, the virtual piece of equipment 35 can be considered virtually an arrangement of antenna elements, such as transmission and receiving elements, for the environment sensing, which is larger in comparison with the actual antenna array 3, as shown by way of example in FIG. 3.

In particular, the virtual antenna array 35 can be deployed by simultaneous emission of frequency-modulated multiband transmission signals 38. The frequency-modulated multiband transmission signal can be manifold in the frequency domain. Objects that fall within the spectral range of the individual modulation bandwidth can be detected and resolved by the enlarged virtual piece of equipment 35 in innervation. To this end, two different circuits can be integrated in an electronic-photonic and co-integrated semiconductor circuit, so that two different gigahertz frequency bands can be generated with one optical carrier signal. This uses the present concept and, in particular, the proposed sensor system 2.

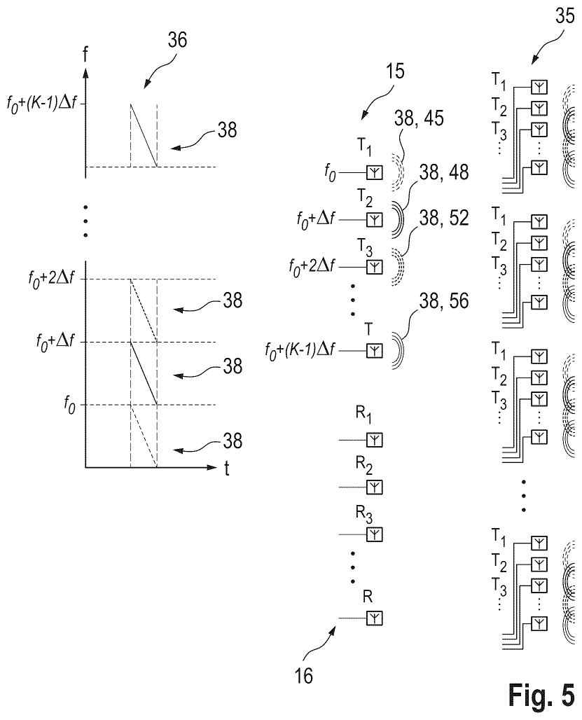

FIG. 5 shows, proceeding from the previous embodiments, a schematic representation with regard to the generation of the virtual antenna array 35.

FIG. 5 shows, by way of example, the transmitter 15, which can have various transmission elements. In this case, the different signals 38 in the diagram 36 are each emitted by their own transmission antenna. Subsequently, corresponding responses or backscatter signals can be received by the receiver 16 with receiving antennas. On the basis thereof, the virtual antenna array 35 can be generated which, in comparison with the actual antenna elements of the apparatus 15, 16, has a plurality of antennas, since actual antennas and virtual antennas are combined. The virtual antenna array 35 is calculated, for example, after the actual reception signals are received.

In particular, FIG. 5 shows a diagram of the virtual antenna array 35 or of a virtual piece of equipment generated by simultaneous emission of frequency-modulated multiband signals.

In the following figures, different variants are now explained in order to carry out the simultaneous emission of signals that are frequency-shifted relative to one another in order be able to deploy or else generate the virtual antenna array 35.

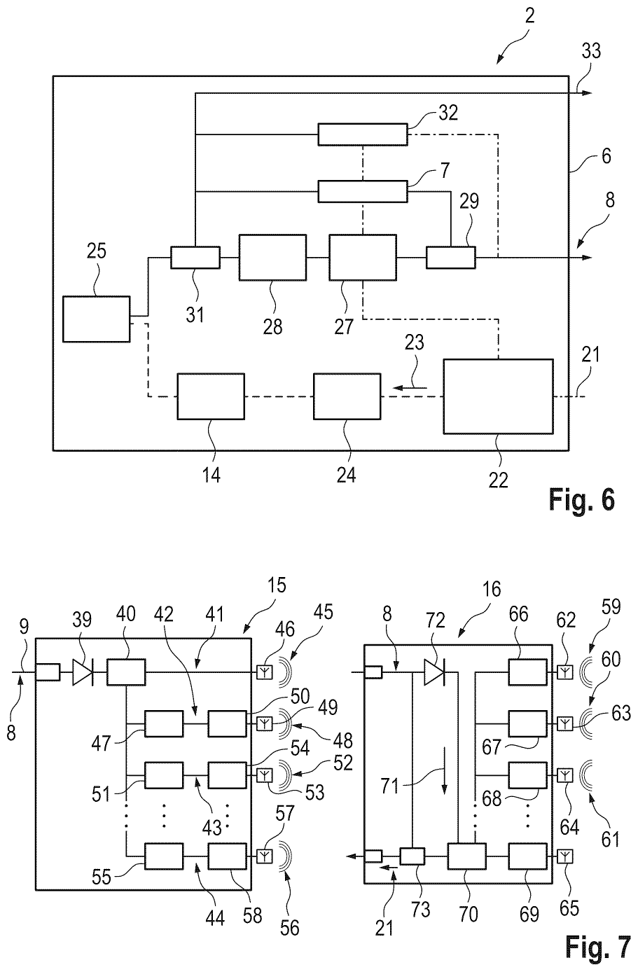

FIG. 6 shows a further conceivable embodiment of the sensor system 2. Here, the sensor system also comprises the processor 6, which in this embodiment may have a different configuration or else be equipped differently.

The sensor system 2 specifically comprises multiple transceiver units, for example the antenna elements 4, which may, for example, be arranged so as to be distributed on the vehicle 1, in particular for environment sensing.

The transceiver units or else antenna elements 4 can be used both to transmit and to emit or else receive signals. Therefore, the transceiver units are combined units for emitting and receiving signals.

In particular, a transceiver unit of this kind may be referred to as a transceiver module. This module can be designated or else formed from an electronic-photonic co-integrated chip (“EPIC chip”). The processor 6, which may be referred to as a central unit, may also be formed from an electronic-photonic co-integrated chip. In particular, the processor 6 is a unit that is physically and/or spatially separated from the transceiver units.

For example, the processor 6 may comprise an optical unit or else the laser apparatus 7 or else a laser. In particular, the optical unit may be designed as an optical source or as a CW laser. The optical transmission signal 8 or else a carrier signal can be generated and thus provided by means of the optical unit. The optical transmission signal 8 may, in particular, be designed as an optical carrier signal in the terahertz frequency range. The processor 6 may, for example, generate the optical carrier frequency. The signal to be transmitted can be modulated to this optical carrier frequency with one eighth of a radar frequency and, for example, be transmitted to the transceiver units. In this way, the frequency can be multiplied. In turn, signals in the gigahertz frequency range can be received by means of the transceiver units.

For example, the processor 6 may be connected to a relevant transceiver unit via a glass fiber 9 as an optical transmission path. Signals, in particular optical signals, can be transmitted from the processor 6 via the glass fiber 9 to the individual transceiver units. In order to, in turn, be able to transmit received signals of the transceiver units back to the processor 6 for evaluation or else signal processing, a relevant transceiver unit can be optically coupled via an optical backward channel 20 to the processor 6.

The electrical emission signal 17 can be emitted by means of at least one of the transceiver units, in particular into the surroundings 18. Likewise, an electrical reception signal 19 that corresponds to the electrical emission signal 17 can, in turn, be received by the transceiver unit. For example, the emission signal 17 may be reflected by an object in the surroundings 18 of the vehicle 1 and thus received as an electrical reception signal 19. The reception signal 19, which may be referred to, for example, as a radar signal, can be forwarded or else transmitted to the processor 6 for evaluation or else signal processing. For this purpose, the electrical reception signal can be converted into an optical reception signal 21 by means of the transceiver unit. For example, said signal can be transmitted via the backward channel 9 of the processor 4. The optical reception signal 21 can, in turn, be converted into an electrical signal 23 by means of an optical-electrical converter 22 or else detector unit of the processor 6. The unit 22 may, for example, be used for optical detection. For this purpose, the conversion may take place, for example, by means of homodyne detection or heterodyne detection. Moreover, the unit 22 may perform a phase measurement and/or a phase length measurement.

Subsequently, digitalization may, in turn, take place by means of a digital interface 24. In the process, analog-digital conversion, in particular, may take place. For this purpose, the digital interface 24 may comprise an analog-digital converter. A processing unit 14 may be arranged downstream. By means of this processing unit, signal processing, for example, can be applied, in particular in the case of a “low-level signal”. For example, a fast Fourier transform (FFT) may be used for this purpose. Subsequently, the digitalized processed electrical signal 23 can be made available to a CPU 25 of the processor 6. Here, in particular, an item of radar information or else environmental information contained in the electrical signal 23 can be evaluated or else processed. Furthermore, an electrical backward channel 26 may be provided, which provides feedback from at least one of the transceiver units to the processor 6 and, in particular, to the digital interface 24.

In order to be able to carry out environment sensing or else detection of the sensor system 2 as stably as possible and with as little noise as possible, the optical transmission signal 8 can be adjusted by means of frequency synthesis or rather gigahertz frequency synthesis. For this purpose, the processor 6 may comprise a synthesis unit 27. The optical transmission signal 8 can be supplied or else transmitted to the synthesis unit 27 for this purpose. For example, modulation is performed before the optical transmission signal 8 is made available to the synthesis unit 27. For this purpose, a modulator or else modulation unit 28, for example, may be provided. Said modulator may be in the form of an arbitrary generator or else arbitrary waveform generator (AWG). An optical controller 29 as well as an optical switch or else distributor 30, for example, may be provided downstream of the synthesis unit 27 in the processor 6, in order to be able to make correspondingly processed signals of the synthesis unit 27 available to the transceiver units via the glass fiber 9. Moreover, a controller 31 may be controlled by the evaluation unit 25 in order to be able to monitor or else control the generation of the optical transmission signal, in particular. Moreover, a controller or else a feedback loop 32 may be provided.

Moreover, the processor 6 is electrically connected to the transceiver units by means of an electrical transmission path 33. An electrical control signal 34 for controlling or else actuating the transceiver units or else antenna elements 4 may be transmitted via this electrical transmission path 33.

In particular, the processor 6 serves to generate an optical carrier signal, the optical transmission signal 8, and to feed same into a gigahertz frequency synthesis unit, for example the synthesis unit 27. The synthesized gigahertz signal may be transmitted in the optical spectral range via fiber, i.e., the glass fiber 9, to the transceiver units, such that, for example, a 77 gigahertz signal can be emitted or else sent out from transceiver units. The signal detection may, in turn, take place in reverse. All data can be processed in the processor 6.

In the diagram of FIG. 6, the optical carrier signal 8 can be referred to as an optically frequency-modulated carrier signal. This signal can be fed in in a gigahertz frequency synthesis unit, such as in the synthesis unit 27, and the synthesized gigahertz signal can be forwarded in the optical spectral range to the transmitter 15 to be emitted, for example, as a 77 GHz signal.

FIG. 7 shows, by way of example, a further diagram of the transmitter 15 and of the receiver 16. This figure shows a variant for how the simultaneous transmission of frequency-shifted signals can be carried out. First, the optical carrier signal 8 can be supplied or else transmitted to the transmitter via glass fiber 9 on an input side or else coupling region. The optical transmission carrier signal 8, which can be referred to, for example, as an optical multiband signal, can first be converted by means of an optical-electronic converter, such as a photodiode 39, into an electrical signal, in particular an electrical multiband signal. This signal can optionally then be amplified or else processed by an amplifier 40.

To emit the different frequency-shifted signals, the transmitter 15 can be divided up into various or else multiple transmission paths 41 to 44. For example, the electrical emission signal, which is amplified after the amplifier 40 and can be referred to as the first electrical emission signal 45, can be emitted by a first transmission unit 46. Thus, a first electrical emission signal 45 can be a basic signal which has the same frequency as the optical carrier signal 8, for example.

The electrical signal, after conversion by the photodiode 39, can in particular be provided or else transmitted to all transmission paths 41 to 44.

Furthermore, the second transmission path 42 can have a second frequency conversion unit 47, by means of which a second electrical emission signal 48 can be generated. In this case, the optical carrier signal 8 and predetermined frequency shift information can be taken into account. The second electrical emission signal 48 can be emitted by a second transmission unit 49. For example, the second electrical emission signal 49 can be amplified before being emitted by a second amplifier unit 50.

The optional third transmission path 43 can also have a frequency conversion unit, i.e., a third frequency conversion unit 51, by means of which a third electrical emission signal 52 can accordingly be generated, so that said signal can be emitted by a third transmission unit 53. For this purpose, the third electrical emission signal 52 can, in turn, be amplified by means of a third amplifier unit 45 before being emitted.

In addition to the embodiments relating to the second and third transmission path 42, 43, further transmission paths 44 can be provided which, in turn, have further frequency conversion units 55 for providing or else converting further electrical emission signals 56. Thus, these signals can be emitted, in turn, by means of further transmission units 57. The further transmission paths 44 can likewise have further amplifier units 58.

In other words, the transmitter 15 can provide, according to how many different electrical emission signals 45, 48, 42, 56 are to be emitted, a corresponding number of transmission paths 41 to 44. In particular, each transmission path can have or else contain the frequency conversion unit, the amplifier, and the transmission unit.

With respect to the electrical emission signals 45, 48, 52, 56, reference can be made to the embodiments relating to FIGS. 4 and 5. As already explained there, the electrical emission signals 45, 48, 42, 56 are frequency-shifted and therefore have different frequencies or else frequency bands from one another. In particular, the transmitter 15 can be designed to emit, in a transmission process, the electrical emission signals 45, 48, 52, 56 simultaneously or else concurrently.

In particular, by means of the processor 6, the optical frequency-modulated carrier signal, i.e., the optical carrier signal 8, can be optically fed in on the side of the transmitter 15 and, upon impinging on the photodiode 39, can be transferred from the optical to the electrical domain. A downstream frequency conversion unit, such as the individual frequency conversion units of the transmission paths 41 to 44, can convert the incoming high-frequency signal to the target frequency to be emitted, i.e., the electrical emission signals 45, 48, 52, 56. Amplification can optionally be carried out before radiation by a corresponding transmission antenna unit, i.e., the transmission units 46, 49, 53, 57.

After the simultaneous emission of the electrical emission signals 45, 48, 52, 56, corresponding electrical reception signals 59 to 61 can be received. For this purpose, the transmitter 16 can have a plurality of receiving units 62 to 65. By means of the receiving units 62 to 65, which can be receiving antennas, the electrical reception signals 59 to 61 based on the emitted electrical emission signals 45, 48, 52, 56 can be received. After being received, the received signals can be processed or else amplified by means of amplifier units 66 to 69 in order to be able to better process and, in particular, transmit said signals afterwards.

The received electrical reception signals 59 to 61 can be provided or else transmitted after being received by a signal processor 70. This can be an electrical or else electronic unit which can be coupled to the receiving units 62 to 65. The signal processor 40 can be designed to mix each electrical reception signal 59 to 61 with one electrical carrier signal 71 which was generated by an optical-electronic conversion unit 72, for example by means of a photodiode 72. Therefore, the original information relating to the optical transmission signal would be mixed with the received signals in order to be able to perform corresponding target detection or else environment sensing. As a result, for example, the optical reception signal 21 or a plurality of such optical reception signals can be transmitted to the processor 6 for environment sensing or else target detection. For this purpose, a corresponding optical modulator 73 can, in turn, then be arranged on the signal processor 70, which can modulate the electrical signals after the signal processor 70, for example with the optical carrier signal 8, and can accordingly generate or else provide the optical reception signal 71.

In other words, all receiving units 62 to 65 can receive signals on the receiving side, which can be a time-delayed multiband signal. This signal can optionally be amplified and mixed with the original transmission signal.

For example, the electrical emission signals 45, 48, 52, 56 can be emitted simultaneously. These signals can, for example, correspond or else be formed analogously to the different frequency-shifted signals 38 in FIG. 5.

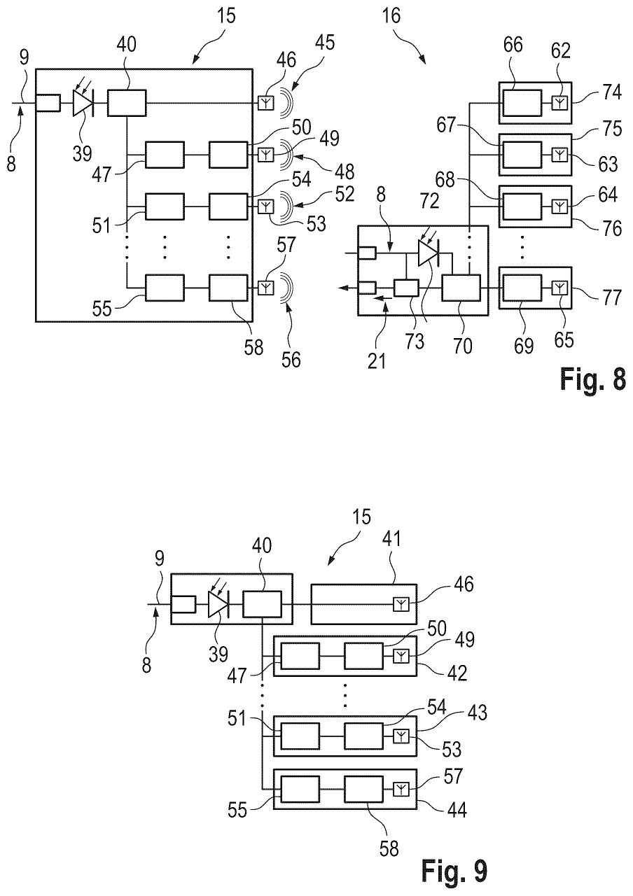

FIG. 8 shows a further example of the transmitter 15 and the receiver 16. In this case, the transmitter 15 can be of analogous design to the transmitter 15 in FIG. 7.

The receiver 16 can be divided up into reception paths 74 to 77 in this example. In this case, each reception path 74 to 77 can have a receiving unit and, for example, an amplifier unit, as explained in FIG. 7. Therefore, the receiver 16 can be of a more flexible design here, since the individual transmission paths 74 to 77, such as individual modules or else circuits, can be handled and thus can be positioned differently. The other embodiments of the receiver 16 from FIG. 7 can likewise be applied here. FIG. 9 shows a further schematic embodiment of the transmitter 15. In comparison with the transmitter 15 shown in FIGS. 7 and 8, the transmission paths 41 to 44 in this embodiment can be units, modules and/or circuits that are physically and/or spatially separated from one another. Thus, the individual transmission paths 41 to 44 and the correspondingly associated transmission units 46, 49, 53, 57 can be flexibly positioned according to the field of application of the sensor system 2.

In particular, the embodiment in FIG. 9 offers the benefit that the transmitter 15 can be referred to as a photonic multiband transmission unit, which enables a modular design with simultaneous emission on different frequency bands for flexibly generating a virtual antenna array.

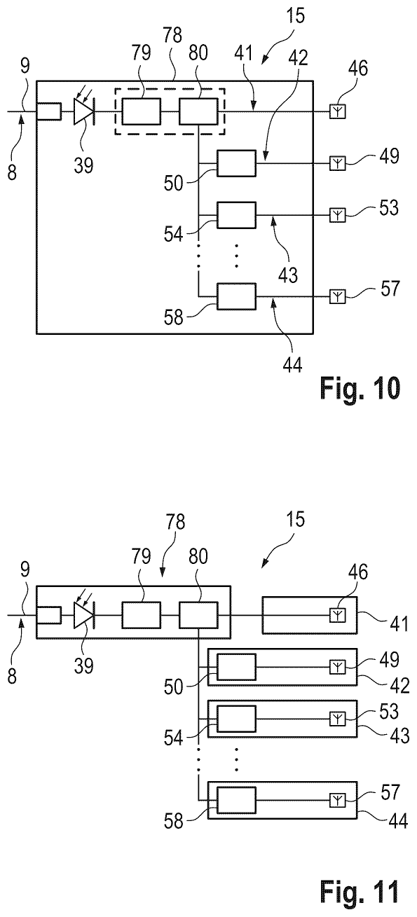

FIG. 10 shows a further exemplary embodiment of the transmitter 15. The difference here in comparison with the embodiments in FIG. 7 to 9 is that the individual transmission paths 41 to 44 no longer have individual frequency conversion units 47, 51, 55 but rather have a central frequency apparatus 78. By means of this frequency apparatus 78, which can be connected or else arranged between the input side of the transmitter 15 and the transmission paths 41 to 44, the different electrical emission signals 45, 48, 52, 56 can be generated or else provided on the basis of the optical carrier signal 8 and the frequency shift information. For this purpose, the frequency apparatus 78 can have a first frequency conversion unit 79, such as a frequency converter, and a frequency-division multiplex 80, for example an integrated FDM (frequency-division multiplexing). Therefore, for example, the multiband signal generated by the frequency converter, i.e., the first frequency conversion unit 79, i.e., the converted optical carrier signal 8, can be multiplexed to the individual frequency bands by means of the frequency-division multiplex 80 and provided to the corresponding transmission paths 41 to 44. The individual transmission paths can, in turn, according to the previous embodiments, perform an amplification of the corresponding signals. The other embodiments of the previous figures can likewise be considered here.

FIG. 11 shows, proceeding from FIG. 10, a further schematic representation of an embodiment of the transmitter 15. The same statements as for FIG. 10 apply, although, in comparison with FIG. 10, the same paths 41 to 44 and the frequency apparatus 78 are arranged on separate modules or else integrated circuits, so that these units are physically and/or spatially separated from one another. In this way, the transmitter 15 can be implemented or else used more flexibly and more universally according to the application of the sensor system 2.

As can be seen here by way of example, on the chip there can be arranged, additionally with respect to the frequency apparatus 78, the input side of the transmitter 15, such as the photodiode 39 and the coupling-in point. In contrast, in FIG. 10 all components in the transmitter 15 are by comparison arranged or else integrated on a chip or else module.

In the following, a schematic sequence is explained for how the proposed sensor system 2 can be used to carry out improved environment sensing.
1. Central unit, such as the processor 6, provides control signals and optical signal, such as the carrier signal
2. Optical signal is transmitted to GHz frequency synthesis unit
3. GHz signal is modulated to optical carrier signal and transmitted to radar front end (EPIC chips)
4. Detection of the optical carrier signal in the EPIC chip by photodiode corresponds to frequency conversion in low GHz spectral range, e.g., 6 or 9 GHz
5. Forwarding the GHz signal to two circuits:
   a. Amplification of the low GHz spectral range and emission by an antenna
   b. Frequency conversion, e.g., to the 77 GHz spectral range, amplification, and emission by an antenna
6. Forwarding the electronic GHz signal to antenna
7. Detection of the reflected radiation by antenna and return of the reception signal to the central station by modulation to optical carrier signal
8. Detection of the optical radiation in central station, ADC sampling, and coherent processing
9. Individual and/or joint coherent or incoherent processing of the data from both frequency bands.
10. Forwarding the data, e.g., to an environment model

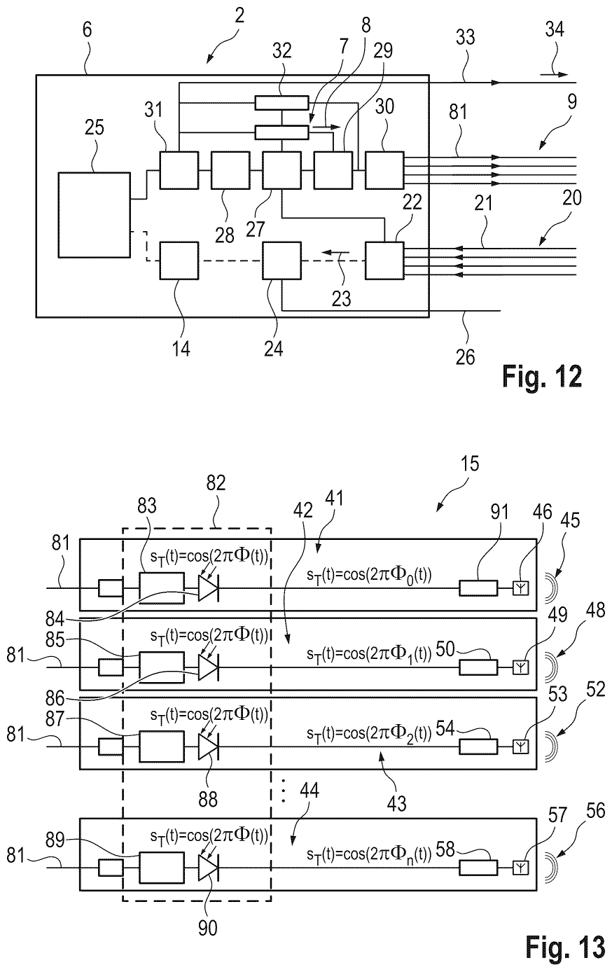

In the following FIG. 12 to 17, further embodiments of the computing unit 6, the transmitter 15, and the receiver 16 are explained. In this case, said embodiments have modifications, in particular minor modifications, in order to realize the simultaneous emission or else transmission of the electrical emission signals 45, 48, 52, 56.

The statements given in regard to the processor 6, the transmitter 15, and the receiver 16 apply here at least in part (FIG. 6 to 11).

FIG. 12 shows a further schematic embodiment of the processor 6, proceeding from FIG. 6. Here, in contrast to the statements made in regard to FIG. 6 to 11, optical transmission signals 81 can be generated by the processor 6 on the basis of the optical carrier signal 8 and, in particular, a frequency shift specification. In particular, these optical transmission signals 81 can be generated here by modulating the optical carrier signal 8. Above all, these optical transmission signals 81 can be frequency-shifted and/or frequency-modulated relative to one another. In this respect, reference can be made to the embodiment of the signals 38 which are frequency-shifted relative to one another in FIG. 4 and FIG. 5. In a similar embodiment, the optical transmission signals 81 can be configured in terms of their frequency shift from one another. In particular, for example, a gigahertz signal can be modulated to the optical carrier signal 8 here and transmitted to the transmitter 15. In order to select or else divide up the different optical transmission signals 81 which are frequency-shifted relative to one another, the optical switch or else the distributor 30 can be used or else applied here.

FIG. 13 shows, proceeding from FIG. 12, a schematic representation of the transmitter 15. In contrast to the embodiments in FIG. 7 to 11, the optical transmission signals 81 are transmitted to all transmission paths 41 to 44. In this variant, the transmitter 15 can have a signal generator 82, which can consist of a plurality of constituent parts. The signal generator 82 can have a plurality of optical filter units and optical-electrical converters. By means of the signal generator 82, the electrical emission signals 45, 48, 52, 56 can be generated on the basis of the optical transmission signals 81 and these generated electrical emission signals 45, 48, 52, 56 can be assigned on the basis of their respective frequencies or else frequency bands to the respectively corresponding transmission paths 41, 42, 43, 44.

For example, the signal generator 82 can have a first optical filter unit 83 which can be arranged in the first transmission path 41. By means of the first optical filter unit 83, the optical transmission signal matching the first electrical emission signal 45 can be selected or else filtered from the plurality of optical transmission signals 81. Thus, the transmission path 41 can use the optical filter unit 83, which can be an optical filter, to itself filter or else select the signal appropriate for it. Subsequently, the selected optical transmission signal can be converted by means of an optical-electrical converter 84, such as a photodiode or a phototransistor, into the first electrical emission signal 45. In contrast to the embodiments in the previous figures, here the first transmission path 41 can also have an amplifier unit 91.

The second transmission path 42 can, in turn, have a second optical filter unit 45, by means of which an optical transmission signal of the optical transmission signals 81 that corresponds to the second electrical emission signal 48 can be filtered and selected. Subsequently, the second electrical emission signal 48 can, in turn, be generated or else converted by an optical-electrical converter 48.

The third transmission path 43 can, in turn, have a third optical filter unit 87, by means of which an optical transmission signal that corresponds to the third electrical emission signal 52 can be filtered and selected from the optical signals 81. Subsequently, an optical-electrical converter 88 can, in turn, be used to convert the optical signal range into the electrical signal range. The further transmission paths 44 can each also have an optical filter unit 89 and, accordingly, optical-electrical converters 90 in order to be able to provide the corresponding further electrical emission signals 56 for the emission.

In other words, each transmission path 41 to 44 can use an optical filter to select the respectively required electrical emission signal 45, 48, 52, 56 by selecting the optical signals 81 with regard to the relevant frequencies and frequency ramps.

In this embodiment, in regard to the temporal emission of the frequency-shifted signals, the receiver 16 from the previous embodiments in FIG. 7 to 11 can be used in respect of the reception or else reception process. In this case, after the frequency-shifted, frequency-modulated emission signals are emitted simultaneously, the time-delayed reception signals could be mixed with the frequency-modulated optical transmission signal.

In particular, by way of example, the transmitter 15 here is again designed in such a way that the transmission paths 41 to 44 are physically and/or spatially separated units.

In an analogous embodiment to those previous, the transmitter 15 here can, in turn, emit the electrical emission signals 45, 48, 52, 56 simultaneously.

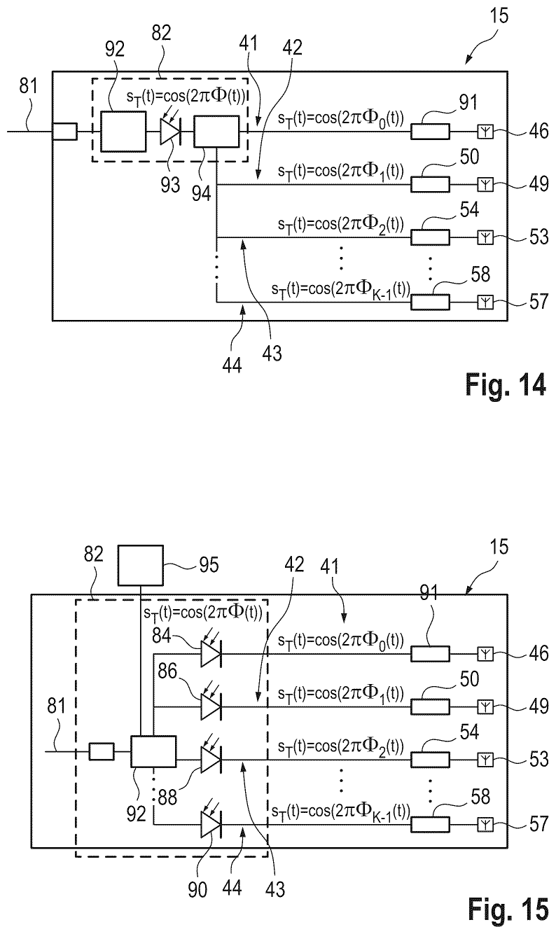

FIG. 14 shows, proceeding from FIG. 13, a further conceivable embodiment of the transmitter 15. It shows, firstly, that all components of the transmitter are integrated on one chip, so that here the transmission paths 41 to 44 are located on a common chip.

Furthermore, the signal generator 82 is of a different design when compared with FIG. 13.

Here, the signal generator 82 has an optical filter unit 92 which provides signals for all transmission paths 41 to 44. Therefore, the transmission paths 41, 44 here do not each have, in comparison with the embodiment in FIG. 13, their own optical filter; rather, signals are accordingly supplied by the higher-level optical filter unit 92. The optical filter unit 92 can, in turn, filter the optical transmission signals 81 on the basis of the respective frequencies or else frequency bands. Subsequently, the filtered optical signals 81 can, in turn, be converted by an optical-electrical converter 93 into the respective electrical emission signals 45, 48, 52, 56. Furthermore, the signal generator 82 here can have an electronic distributor 94. Using this electronic distributor 94, or else switch, the individual transmission paths 41 to 44 can be supplied with the correspondingly associated signals via electronic switching.

FIG. 15 in turn shows a variant proceeding from FIG. 14. Here, the signal generator 82 can, in turn, have a higher-level optical filter unit 92. However, this optical filter unit 92 can be controlled by an, in particular higher-level, electronic filter controller 95. In this case, an optical distributor, for example the optical distributor 94, can be used to distribute the optical signals to the channels or else the transmission paths 41 to 44. An optical switch, such as the optical distributor 94, can accordingly be program-controlled to provide the appropriate signals to the respective transmission paths 41 to 44. In this case, the distribution can be carried out in the optical range and the optical-electrical converters 84, 86, 88, 90 can, in turn, be provided in a corresponding transmission path 41 to 44.

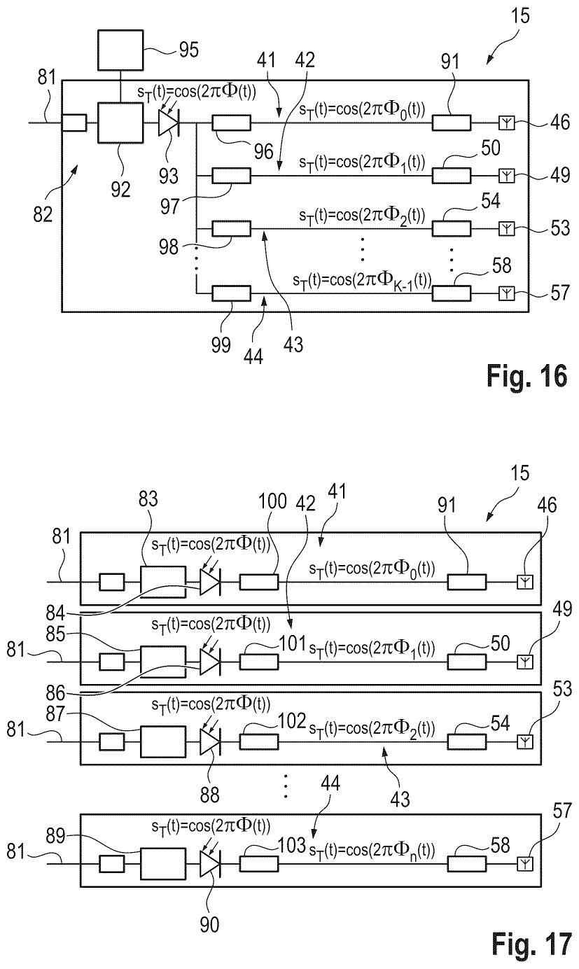

The subsequent FIG. 16 shows, proceeding from FIGS. 14 and 15, a further embodiment which is at least a partial combination of these two embodiments. In turn, the optical filter unit 92 can be controlled here by means of the filter controller 95. Subsequently, the respective signals can, in turn, as in FIG. 14, be accordingly transferred to an electrical range by an optical-electrical converter 93. In contrast to the embodiments in FIGS. 14 and 15, the optical distributor can, in turn, be omitted here and, instead, each transmission path 41 to 44 can have its own electronic filter unit 96 to 99 in order to filter the correspondingly filtered and converted signals so as to filter out or else select for each transmission path 41 to 44 the associated electrical emission signal 45, 48, 52, 56.

FIG. 17 shows, proceeding from FIG. 13, a further conceivable embodiment of the transmitter 15. In this case, in each transmission path 41 to 44, in addition to the respective optical filter units and optical-electrical converters, an additional electronic frequency conversion unit 100 to 103 can be arranged. Thus, each transmission path 41 to 44 can have a corresponding, or else its own, electronic frequency conversion unit 100 to 103. In this way, the electrical emission signal 45, 48, 52, 56 to be provided for the corresponding transmission unit 46, 49, 53, 57 can be processed once more.

In the following, a further conceivable schematic sequence is explained for how the proposed sensor system 2 can be used to carry out improved environment sensing.
1. Central unit provides control signals and optical signals
2. Optical carrier signal is transmitted to GHz frequency synthesis unit
3. GHz signals are modulated to optical carrier signals and transmitted to radar front end (EPIC chips)
4. Optional multiplexing or frequency/wavelength multiplexing of the individual optical signals
5. Signal relevant to channel n (n∈ [symbol] ) is selected by optical filter and front-end EPIC
6. Detection of the optical carrier signal in the EPIC chip by photodiode corresponds to frequency conversion in low GHz spectral range, e.g., 6, 9 or 77 GHz
7. Forwarding the GHz signal to circuit
   a. Amplification of the low GHz spectral range and emission by an antenna
   b. Optional additional frequency conversion
8. Forwarding the electronic GHz signal to antenna(s)
9. Detection of the reflected radiation by antenna(s) and return of the reception signal to the central station by modulation to optical carrier signal
10. Detection of the optical radiation in central station, ADC sampling, and coherent processing
11. Individual and/or joint coherent or incoherent processing of the data from both frequency bands.
12. Forwarding the data, e.g., to an environment model

### LIST OF REFERENCE NUMERALS

1 Vehicle
2 Sensor system
3 Antenna array
4 Antenna elements
5 Radar sensor device
6 Central electronic processor
7 Optical apparatus
8 Optical carrier signal
9 Glass fiber
10 Optical input
11 Optical output
12 Receiving unit
13 Output signal
14 Processing unit
15 Transmitter
16 Receiver
17 Electrical emission signal
18 Surroundings
19 Electrical reception signal
20 Backward channel
21 Optical reception signal
22 Optical-electrical converter
23 Electrical signal
24 Digital interface
25 CPU
26 Electrical backward channel
27 Synthesis unit
28 Modulator
29 Optical controller
30 Optical distributor
31 Controller
32 Feedback loop
33 Electrical transmission path
34 Electrical control signal
35 Virtual antenna array
36, 37 Frequency range diagrams
38 Frequency-shifted transmission signals
39 Photodiode
40 Amplifier
41 to 44 Transmission paths
45 First electrical emission signal
46 First transmission unit
47 First frequency conversion unit
48 Second electrical emission signal
49 Second transmission unit
50 Second amplifier unit
51 Second frequency conversion unit
52 Third electrical emission signal
53 Third transmission unit
54 Third amplifier unit
55 Further frequency conversion unit
56 Further electrical emission signal
57 Further transmission unit
58 Further amplifier
59 to 61 Electrical reception signals
62 to 65 Receiving units
66 to 69 Amplifiers
70 Signal processor
71 Electrical carrier signal
72 Optical-electrical converter or photodiode
73 Optical modulator
74 to 77 Reception paths
78 Frequency apparatus
79 First frequency conversion unit
80 Frequency-division multiplex
81 Optical transmission signal
82 Signal generator
83 First optical filter unit
84 Optical-electrical converter
85 Second optical filter unit
86 Optical-electrical converter
87 Third optical filter unit
88 Electrical-optical converter
89 Further optical filter unit
90 Further optical-electrical converter
91 Amplifier
92 Optical filter unit
93 Optical-electrical converter
94 Electronic distributor
95 Filter controller
96 to 99 Electronic filter unit
100 to 103 Frequency conversion unit

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A sensor system for environment sensing, comprising:
an optical system for generating an optical carrier signal;
a transmitter which has a plurality of transmission units, wherein the transmitter is configured to emit electrical emission signals; wherein
a first transmission path of the transmitter, which path is configured to provide a first electrical emission signal, which is based on the optical carrier signal, to a first transmission unit of the plurality of transmission units, which is arranged on the first transmission path;
at least one second transmission path of the transmitter, which path is different from the first transmission path and is configured to generate a second electrical emission signal, which is based on the optical carrier signal, and to provide it to a second transmission unit of the plurality of transmission units, which is arranged on the second transmission path;
a processor is configured to generate, on the basis of the optical carrier signal, a plurality of optical transmission signals that are frequency-shifted relative to one another, and to provide the plurality of optical transmission signals to the transmitter;
a signal generator of the transmitter, which is configured to generate the electrical emission signals on the basis of the optical transmission signals and to assign the electrical emission signals to the relevant transmission path on the basis of their respective frequencies;
the transmitter is configured to emit, simultaneously, in a transmission process, the first electrical emission signal with the first transmission unit and the second electrical emission signal with the second transmission unit.

2. The sensor system of claim 1, wherein
at least one third transmission path of the transmitter, which path is different from the first and second transmission path and is configured to provide a third electrical emission signal, which is different from the first and/or second electrical emission signal, to a third transmission unit of the plurality of transmission units, which is arranged on the third transmission path; wherein
the signal generator is configured to generate the third electrical emission signal on the basis of the optical transmission signals and to assign it on the basis of its frequency to the third transmission path; and wherein
the transmitter is configured to emit, simultaneously, in the transmission process, the first electrical emission signal with the first transmission unit, the second electrical emission signal with the second transmission unit, and the third electrical emission signal with the third transmission unit.

3. The sensor system of claim 1, wherein
the signal generator has an optical filter which is configured to filter the optical transmission signals on the basis of their respective frequencies;
the signal generator has an optical-electrical converter which is configured to convert the filtered optical transmission signals into the electrical emission signals; and
the signal generator has an electronic distributor which is configured to provide the respectively associated converted electrical emission signals to the transmission paths.

4. The sensor system of claim 1, wherein
the signal generator has an optical filter which is configured to filter the optical transmission signals on the basis of their respective frequencies, wherein the optical filter can be controlled using an electronic filter controller;
the signal generator has an optical distributor which is configured to provide the respectively associated optical transmission signal to the transmission paths; and
each transmission path has a corresponding optical-electrical converter which is configured to convert the optical transmission signal provided by the optical distributor into the electrical emission signal associated with the transmission path.

5. The sensor system of claim 1, wherein
the signal generator has an optical filter which is configured to filter the optical transmission signals on the basis of their respective frequencies;
the signal generator has an optical-electrical converter which is configured to convert the filtered optical transmission signals into the electrical emission signals, and wherein
each transmission path has a corresponding electronic filter which is configured to the select the electrical emission signal associated with the corresponding transmission path from the converted electrical emission signals.

6. The sensor system of claim 1, wherein
the signal generator has a first optical filter and at least one second optical filter;
the first optical filter is integrated in the first transmission path and the second optical filter unit is integrated in the second transmission path;
the first optical filter is configured to filter such an optical transmission signal of the plurality of optical transmission signals on which the first electrical emission signal is based; and wherein
the second optical filter is configured to filter an optical transmission signal of the plurality of optical transmission signals on which the second electrical emission signal is based.

7. The sensor system of claim 1, wherein
the first transmission path and at least the second transmission path are located together on a common integrated circuit; or
the first transmission path and at least the second transmission path are each located on their own integrated circuit.

8. The sensor system of claim 1, wherein
a receiver which has a plurality of receiving units, wherein the receiver is configured to receive electrical reception signals which are based on the emitted electrical emission signals; and wherein
the receiver has a plurality of reception paths, wherein each reception path has a receiving unit of the plurality of receiving units, in particular the receiver has a signal processor which is coupled to the receiving units, wherein the signal processor is configured to mix an electrical reception signal of the electrical reception signals with an electrical transmission signal that can be generated by an optical-electrical conversion of a corresponding optical transmission signal.

9. A vehicle having the sensor system of claim 1.

10. A method for operating a sensor system, said method comprising:
generating an optical carrier signal;
generating a plurality of optical transmission signals which are frequency-shifted relative to one another;
generating electrical emission signals on the basis of the optical transmission signals;
assigning the electrical emission signals to a relevant transmission path on the basis of their respective frequencies;
providing a first electrical emission signal to a first transmission unit;
providing a second electrical emission signal a the second transmission unit; and
simultaneously emitting the first and second electrical emission signal in the transmission process.
